(19) United States
(12) Patent Application Publication
(10) Pub. No.: US 2007/0172053 A1
(43) Pub. Date: Jul. 26, 2007

(54) Method and system for microprocessor data security

(76) Inventor: Jean-Francois Poirier, Deux-Montagnes (CA)

Correspondence Address: BERESKIN AND PARR, 40 KING STREET WEST, BOX 401, TORONTO, ON, M5H 3Y2, CA

(21) Appl. No.: 11/350,839

(22) Filed: Feb. 10, 2006

Related U.S. Application Data
(60) Provisional application No. 60/651,636, filed on Feb. 11, 2005.
(60) Provisional application No. 60/693,801, filed on Jun. 27, 2005.

(51) Int. Cl. H04L 9/28; G06F 12/14; H04L 9/00; H04L 9/32; H04K 1/00; G06F 11/30

(52) U.S. Cl. 380/28; 713/189; 713/193

(57) ABSTRACT

Embodiments of the invention relate generally to methods and systems for microprocessor data security, involving data encryption and decryption of stored data in, or in communication with, a computer microprocessor. Such encryption and decryption can be performed on a per-byte basis. Such encryption and decryption involves performing a logic operation on the byte using a decryption key or encryption key to generate a respective decrypted byte or encrypted byte. The key can be fixed or variable or a combination of both. The key is encoded in a dedicated hard-wired key circuit within the microprocessor and accessible to encryption and decryption circuitry within the microprocessor.

### CROSS REFERENCE TO RELATED APPLICATIONS

This application claims the benefit of U.S. Provisional Patent Application Ser. No. 60/651,636, filed Feb. 11, 2005 and U.S. Provisional Patent Application No. 60/693,801, filed Jun. 27, 2005, the entire contents of both of which are hereby incorporated by reference.

### FIELD OF THE INVENTION

The present invention relates to methods and systems for microprocessor data security. In particular, the invention relates to methods and systems for data encryption and decryption of stored data in, or in communication with, a computer microprocessor on a per-byte or per-word basis.

### BACKGROUND OF THE INVENTION

Data security is an important issue for many aspects of business, particularly as it relates to stored proprietary data. For example, computer program source code stored in flash memory (or other form of read-only memory) can be valuable proprietary information. Others can wish to copy operational source code in order to avoid having to write their own source code for their competing computer products or electronic devices.

Those attempting to copy source code from a flash memory can, for example, slice through the die of the memory chip and examine the source code stored therein in its raw data form so that it can be copied into the memories of competing products. There have been some attempts to prevent data internal to a microprocessor from being accessed, but these do not prevent die slicing and none of the known technologies can adequately protect information in any device external to the microprocessor. Thus, source code stored in flash memory or other non-volatile memory can be vulnerable to copying unless it can be better protected.

Other techniques also exist for assisting in the reverse engineering of microprocessors and their stored data. For example, for circuits that have particular conductor configurations, these configurations can sometimes be read by sensing the magnetic polarization of the conducting elements in the circuit. Thus, even registers storing codes for use by the microprocessor in data encryption or decryption can have their data contents read by current security-cracking technology.

It is desirable to provide for improved data security of stored data by addressing or ameliorating one or more shortcomings or disadvantages associated with conventional security techniques, or to at least provide a useful alternative to such conventional security techniques.

### SUMMARY OF THE INVENTION

On a broad level, the invention can be used to protect any type of information that a microcontroller can process, including data stored within a CPU architecture and externally stored data. This can include, for example, firmware or source code, audio or video signal data, configuration settings, system variables and any other information which is desired to be protected from unauthorized reading and copying.

In one aspect, the invention relates to a method of retrieving data, the method comprising:

reading at least one byte of stored data from a memory associated with a processor;

for each byte read, performing a logic operation on the byte using a decryption key to generate a decrypted byte, wherein the decryption key is encoded by a dedicated key circuit accessible to the processor; and providing each of the decrypted bytes to the processor for processing thereof.

The stored data retrieved by this method has been encrypted on a byte-by-byte basis using an encryption key corresponding (i.e. cryptologically matched or paired) to the decryption key prior to its storage in the non-volatile memory. The logic operation used in the decryption is an inverse logic operation to that used in the encryption. Thus, the method of retrieving generates decrypted bytes based on the initially (encrypted) stored data in the non-volatile memory.

The stored data can be, for example, stored computer program source code. Alternatively, the stored data can be encrypted audio or video signal data. In alternative aspects, the memory need not be non-volatile. The memory can include, for example, random access memory (RAM), registers or cache memory.

The decryption key can be a fixed decryption key or it can be a variable decryption key. In one embodiment, first and second decryption keys are used, with one of the keys being fixed and the other being variable. The variable decryption key can be different for each byte. If more than one decryption key is used, corresponding logic operations are used for each decryption key to decrypt the byte. The logic operations can be the same or different.

Example logic functions include an exclusive-or (XOR) operation and a hash function. Other examples include swapping the locations of sets of bits (for example, exchanging the location of the two blocks of four bits within the byte) and adding or subtracting a fixed value to or from the byte. Other forms of bit transformation can be used as part of the logic operation, providing that the transformation is readily reversible (as it will need to have been encrypted with the inverse of the logic operation used in the decryption).

If the logic operation is an XOR operation, the data byte and the encryption key are operands of the XOR operation. If the logic operation is a hash function, the hash function is encoded with the decryption key and, using the hash function, bits of the data byte are transposed to generate the decrypted byte based on the decryption key.

The variable decryption key can correspond to respective memory locations of the stored data bytes. Alternatively, another numeric variable can be used, such as the value of the program counter or a predetermined list of sequential or random numbers. Alternatively, a variable value can be added to or subtracted from the bytes to be stored. A linear feedback shift register (LFSR) can be used for pseudo-random number generation of the variable key or a variable value used to form the variable key, based on a predetermined seed valve.

In another aspect, the invention relates to a method of storing data, the method comprising:

receiving at least one byte of data to be stored in a memory associated with a processor;

for each byte, performing a logic operation on the byte using an encryption key to generate an encrypted byte, wherein the encryption key is encoded in a dedicated key circuit accessible to the processor; and

storing each of the encrypted bytes in the non-volatile memory.

The data to be stored can be, for example, computer program source code or it can be audio or video signal data. The method of storing data is generally performed in an inverse manner to the method of retrieving data described above. Accordingly, the above-described method of retrieving data is particularly suited to retrieving data stored by the present method of storing data. For this reason, the decryption key used in retrieving the stored data is the same as the encryption key used to encrypt the data prior to storage. Further, the logic operation performed in retrieving the data is an inverse operation to the logic operation performed in storing the data, thereby allowing the original data to be recovered from the encrypted data.

In another aspect, the invention relates to a method of data processing including performing the above-described method of storing data, followed by performing the above-described method of retrieving data.

A still further aspect of the invention relates to a method of retrieving stored data, the method comprising:

reading a plurality of words of stored instruction data from a non-volatile memory;

for each word, performing a logic operation on the word using a decryption key to generate a decrypted word;

providing each of the decrypted words to a processor for processing thereof.

In a still further aspect, the invention relates to a method of storing data, the method comprising:

receiving a plurality of words of instruction data to be stored in a non-volatile memory;

for each word, performing a logic operation on the word using an encryption key to generate an encrypted word; and

storing each of the encrypted words in the non-volatile memory.

Other aspects of the invention relate to data storage and retrieval apparatus, circuits and systems having means to perform the methods described above. For example, such aspects can comprise encode logic circuits or decode logic circuits, as appropriate, for encoding or decoding the data on a byte-by-byte or word-by-word basis. In a further aspect, the invention relates to a CPU architecture comprising an encode logic circuit for encoding bytes or words of data for storage in a non-volatile memory and decode logic for retrieving the encoded data bytes or words from memory and decoding them.

A further aspect of the invention relates to computer apparatus comprising a processor, a non-volatile memory, encryption and decryption circuitry and a key circuit. The non-volatile memory is accessible to the processor for storing and reading a plurality of bytes of data. The encryption circuitry is configured to receive data to be stored in the non-volatile memory, encrypt each byte based on a key by using a first logic operation and pass each encrypted byte to the non-volatile memory for storage. The decryption circuitry is configured to receive encrypted bytes of data read from the non-volatile memory, decrypt each byte based on the key using a second logic operation that is an inverse of the first logic operation and pass each decrypted byte to the processor. The key circuit has the key formed therein and is accessible to the encryption circuitry and the decryption circuitry. The key can be fixed or variable or there can be a fixed key and a variable key. The key circuit can be a fixed key circuit or a variable key circuit or both.

Preferably, the fixed key circuit has the fixed key formed therein in a non-volatile manner according to permanent electrical connections formed between selected ones of a plurality of conductors in the fixed key circuit. The fixed key circuit is preferably accessible only to the encryption circuitry and decryption circuitry. The fixed key can be based on a serial number of the processor or of a device housing the processor. The fixed key circuit can be formed as part of the encryption circuitry and/or the decryption circuitry and can be comprised in an arithmetic logic unit (ALU) of the processor. The non-volatile memory can store encrypted computer program source code.

In one embodiment, the apparatus further comprises a variable key circuit configured to provide a variable key to the encryption circuitry and the decryption circuitry. The encryption circuitry is, in this embodiment, further configured to encrypt each byte based on the variable key using a third logic operation before passing the encrypted byte to the volatile memory. The decryption circuitry is, in this embodiment, further configured to decrypt each byte based on the variable key using a fourth logic operation that is an inverse of the third logic operation before passing the decrypted byte to the processor. The variable key is different for at least some of the bytes. The logic operations can be all XOR operations or hashing operations or an appropriate combination of XOR and hashing operations.

In one embodiment, the variable key is generated by a LFSR circuit according to a predetermined seed value. The LFSR circuit is preferably an eight-stage LFSR circuit having fixed tapping points. Alternatively, the variable key can correspond to respective memory locations of the encrypted bytes stored in the non-volatile memory. The seed value can be a randomly selected value or it can be (or be derived from) the device serial number or other unique identifier.

Preferably, the encryption circuitry encrypts all data to be stored in the non-volatile memory, including data delimiter bits. Accordingly, a prospective copier of the encrypted data will not be aided by data delimiters in order to determine which bytes of the stored encrypted data is pertinent data, as opposed to overhead bits.

The data storage and retrieval apparatus, circuitry, systems, methods and architecture of embodiments of the invention improve the security of stored data by encrypting and decrypting the data on a byte-by-byte or word-by-word basis, so that, if copied from the memory in which it is stored, the encrypted data will be useless to the copier without access to the encryption/decryption key. A fixed key and/or a variable key can be used for the encryption and decryption.

The fixed key can be derived from the serial number of the device in which the data is stored, for example. As the serial number of the device is generally only known to the device manufacturer, copiers will not have access to the encryption/decryption key. Thus, the fixed key is hard-coded by the device manufacturer into the fixed key circuit. Subsequently, when it is desired to store the device source code or other sensitive information, the data to be stored is passed through the fixed key circuit and thereby encrypted before being stored. The entity that writes its source code into the device memory has the benefit of its source code being encrypted but does not know the fixed key and need not maintain its secrecy.

The key can be recorded within the CPU architecture and/or specific circuits designated by the manufacturer by means of hardwired circuits, possibly using configuration fuses such as are employed in programmable read-only memory (PROM) devices, or stored in an obscure register. Thus embedding the encryption/decryption key within the CPU core renders it practically indiscernible to potential memory copiers. The fixed key is thus hard-wired or otherwise hard-coded into the CPU circuitry. This hard-wiring of the fixed key is permanent (i.e. non-volatile), programmable one time only (OTP) and preferably consists of a matrix of conductors which are physically linked according to the programmed fixed key. Such physical links generally cannot be read by devices which sense magnetic polarization, thus providing greater security of the fixed key. In avoiding using a programmable register to store the fixed key, embodiments of the invention avoid the vulnerability of registers to such snooping technologies as magnetic polarization sensors.

The combination of using fixed and variable encryption/decryption keys provides further data security for the stored data. The variable key can be set to vary for each byte or word according to a series of numbers, for example, such as the memory locations of the particular bytes or another sequence of pre-determined (but possibly randomized) numbers. In another example, the variable key can be generated for each byte or word according to the pseudo-random output of a LFSR circuit. Thus, the same original data stored in different locations will be stored as differently encrypted data within the device (because the variable key varies for each byte or word) and across different devices (because the fixed key can be device-specific).

A further advantage of embodiments of the invention is that the encryption and decryption can be performed at high speed because it is performed on a byte-by-byte basis, and thus does not adversely affect CPU performance.

### BRIEF DESCRIPTION OF THE DRAWINGS

Embodiments of the invention are described in further detail, but by way of example only, with reference to the accompanying drawings, in which:

FIG. 1 is a block diagram of a data encoding arrangement according to one embodiment;

FIG. 2 is a block diagram of a data decoding arrangement according to one embodiment;

FIG. 3 is a block diagram of a decoding arrangement within a central processing unit (CPU) according to one embodiment;

FIG. 4 is a block diagram of another decoding arrangement within a CPU according to another embodiment;

FIG. 5 is a process flow diagram of a method of encoding data according to one embodiment;

FIG. 6 is a process flow diagram of a method of decoding data according to one embodiment;

FIG. 7 is a circuit diagram of an illustrative example of a hashing matrix;

FIG. 8 is an illustration of a linear feedback shift register (LFSR) for use in generating a variable key according to one embodiment; and

FIG. 9 is an example hashing matrix combined with an XOR circuit according to another embodiment.

### DETAILED DESCRIPTION OF THE INVENTION

Embodiments of the invention generally relate to methods and systems for encoding and decoding data which facilitate greater data security than is presently available for some forms of data storage. When the data is to be stored (i.e. when it is first written to the read-only memory), the data is encoded (encrypted) on a per-byte basis. The encryption is performed using a logic operation to convert the byte into an encoded form of the same size. Such a logic operation can include, for example, performing the exclusive-or (XOR) logic function with a key or passing the byte or word through a hash function to transpose the locations of the data bits within the byte or word. This encryption can be performed using at least a fixed key and can optionally undergo a further encryption using a logic function with a variable key.

For ease of reference, the data encryption and decryption described herein is described as being performed on a per-byte basis. It should be understood, however, that bit numbers other than 8 (i.e. a byte), can be used as the information quantum for the encryption and decryption. For example, if an instruction set uses a 16 bit word, the encryption and decryption can be performed on a per-word basis. Likewise, if the instruction set uses a 32 bit word, the encryption and decryption can be performed in relation to a 32 bit information quantum. On the other hand, the encryption or decryption can be performed on only 4 bits (sometimes called a nibble) at a time. Thus, while this description refers to bytes, it will be understood that other sizes of information quanta can be employed and the implementation of such alternative information quanta will be apparent to those skilled in the art in light of the present disclosure.

Further, even where the data word is greater then eight bits, for example sixteen or thirty-two bits, the bytes within each word can be encrypted separately. Thus, if a variable key is employed the bytes within a data word will be encrypted using different keys.

The terms “encrypt” and “encode” and respective variations thereof are used interchangeably in this description. Similarly, the terms “decrypt” and “decode” and their variations are also used interchangeably.

In order to read the encrypted information once it has been stored, it is necessary to have access to the fixed key and the variable key (if it was used in the initial encryption). The fixed key is provided by a hardwired logic circuit embedded within the CPU architecture and located apart from the flash memory or other data storage. For encrypted flash memory, for example, the source code as stored therein can be read and processed in the CPU, but it will not yield meaningful instructions or information unless it has first been decoded (decrypted). This decryption can only be performed using the fixed key hard-coded into the CPU architecture and which is unique to the particular CPU on which the source code was originally stored in encrypted form. Accordingly, while the source code from the original machine can be copied, it cannot be used on any other machine as the other machine will not have access to the hard-coded fixed key. Further, the decryption key can be hardwired into the CPU architecture in a location that is machine-specific but which will not be apparent to those attempting to copy the source code, thus providing enhanced security for the source code.

The fixed key is preferably device-specific. For example, the fixed key can be derived from the serial number of the device which houses the microcontroller or a serial number associated with the microcontroller itself. As the serial number is likely to be longer than the allowable operand length of the logic operations performed in the encryption and decryption processes, the fixed key can be selected as the eight most or least significant bits of the binary coded serial number, for example. However, any other pre-determined selection of bits can be used to derive the fixed key from the serial number. Using the device or microcontroller serial number to determine the fixed key advantageously means that the fixed key is device-specific and that the same data encrypted and stored on another device will appear to be different stored data. Alternatively, instead of the device serial number, a different stored device-specific code (known only to the device manufacturer) can be used to derive the fixed key.

With reference to the drawings, embodiments of the invention are shown and described in further detail. For ease of reference, wherever a feature is first introduced in relation to a figure, that feature is denoted by the number of the figure in the hundreds column. For example, a feature introduced in FIG. 2 will have a reference number between 200 and 299. That reference number will then be used in subsequent figures to denote the same, or a similar feature, as applied to the same or another embodiment.

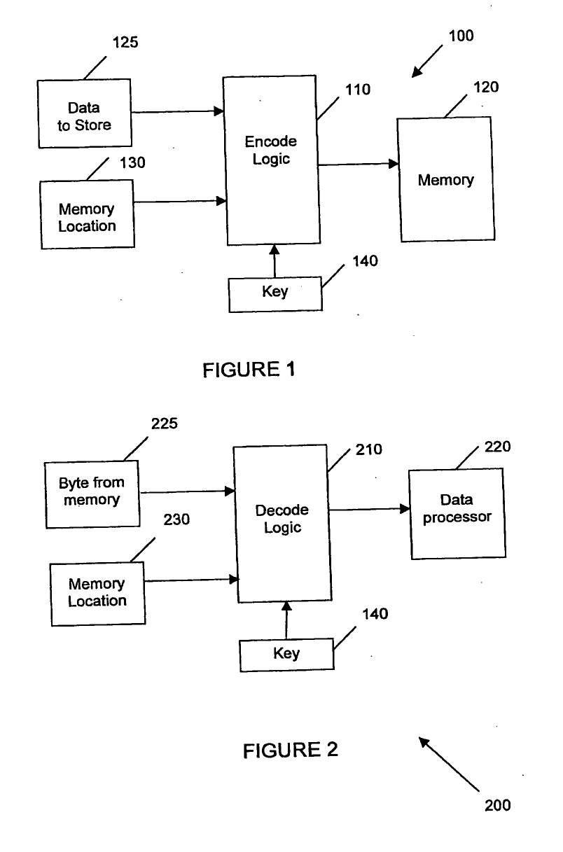

FIG. 1 shows a data encoding arrangement 100 for encoding data prior to storage. Data encoding arrangement 100 comprises encode logic 110 which receives data 125 for encoding and subsequent storage in a memory 120. Encode logic 110 also receives as input the memory location 130 for the data 125 so that the data 125 is stored in the correct location within memory 120. A key 140 is input into encode logic 110 to facilitate encryption of data 125 by performing a logic function thereon using key 140. Data 125 can be encrypted by means of an XOR logic function using the data byte as one operand and the key as the other operand, generating encrypted data of the same length as the unencrypted data 125 (i.e. byte-length or word-length).

Encode logic 110 stores the encrypted byte in memory 120 at the location specified by memory location 130. Optionally, encode logic 110 can further encrypt or encode the data prior to storage by using the memory location 130 as an operand in a further logic operation, with the key-encrypted data being the other operand.

Using the memory location 130 as an encryption key advantageously provides a variable encryption key, as the memory location 130 will be different for each byte or word of data 125. The combination of a fixed key 140 with a variable key advantageously provides greater data security for data stored in memory 120. A variable key other than the memory location 130 can be used, for example such as the program counter or a pre-determined number sequence. In another example, the memory location (pointer) can be used as a key selection pointer to select a key from a table of keys. In another example, the variable key can be a pseudo-random number determined, for example, by a linear feedback shift register (LFSR) circuit, as shown and described later in relation to FIG. 11.

Encode logic 110 can reside within a pre-fabricated chip or application specific integrated circuit (ASIC) or can be hardwired into a portion of the CPU architecture, preferably coupled to the data bus for directly writing the encoded data to memory 120. Memory 120 can be flash memory or other form of non-volatile memory. Other examples of non-volatile memory include read-only memory (ROM), programmable read-only memory (PROM), erasable programmable read-only memory (EPROM) and electronically erasable programmable read-only memory (EEPROM). Flash memory is a form of EEPROM. While embodiments of the invention are particularly suited to protecting non-volatile memory within the CPU, memory 120 can reside within the CPU architecture or outside of it. External non-volatile memory can include optical storage, such as CDs or DVDs, or other optical, electrical, electro-optical, chemical (molecular) or micro-mechanical storage.

While embodiments of the invention are particularly suited to protecting non-volatile memory, they can also be applied to volatile memory forms, such as RAM, registers or cache. Further, while embodiments of the invention are particularly suited to protecting copy-sensitive firmware or data, it can be applied to any form of data, regardless of the nature of the data.

Depending on the specific memory type of memory 120, one or more circuits or devices can be used with the encode logic 110 and the memory 120 to facilitate loading the encoded bytes into the memory 120. Appropriate circuits or devices for this purpose will be apparent to persons skilled in the art. For example, for standard ROM, PROM, EPROM, EEPROM or flash, a bootloader can be used to feed the bytes to encode logic 110 for encoding prior to storage.

Referring now to FIG. 2, there is shown a data decoding arrangement 200. Data decoding arrangement 200 comprises decode logic 210 for decoding data bytes 225 read from memory and passing the decoded bytes to data processor 220 for processing thereof, for example by execution by an arithmetic logic unit (ALU) within the CPU. Alternatively, if the data is read from a storage device such as an optical disk, it can undergo some form of digital signal processing, for example to generate audio or video signals.

As part of the decoding process, decode logic 210 reads the stored data bytes 225 from memory 120 at a location determined by memory location 230 which is provided to decode logic 210 for each byte 225 to be read. The memory location 230 can be provided by a matrix decoder within the CPU. The matrix decoder uses row and column selection based on the program counter and/or a RAM pointer. Alternatively, the matrix decoder can determine the memory location 230 from indirect addressing.

If the memory location of the byte was used in the encoding process, it is also used by decode logic 210 in the decoding process. An inverse logic function is used to obtain the partially decoded byte from the byte 225 from memory and the memory location 230. This partially decoded byte is then used with the original encoding key 140 to finally decode the data, after which it is provided to data processor 220.

Example logic operations which can be used in the encoding and decoding processes include the XOR function and a hash function. If the XOR function is used, the inverse logic operation of XOR is merely an XOR function. That is, if A XOR B=C then C XOR B=A. If the logic operation is a hash function, then the key 140 is embedded in the hash function, such that the key determines how the bits within the byte or word are transposed by the hash function. An inverse of the hash function merely maps the transposed bits back to their original positions.

Further examples of logic operations which can be used in the encoding and decoding processes include swapping of groups or blocks of bits within the byte and addition or subtraction of a value to or from the byte. The value added or subtracted can be a fixed or variable value, depending on whether a fixed or variable key is used in the relevant logic operation.

Key 140 is preferably hardwired at a location within the CPU architecture which makes it difficult to discern its function (e.g. from observing the entire CPU architecture topography), for example such as within the ALU or within the encode logic 110 and/or decode logic 210.

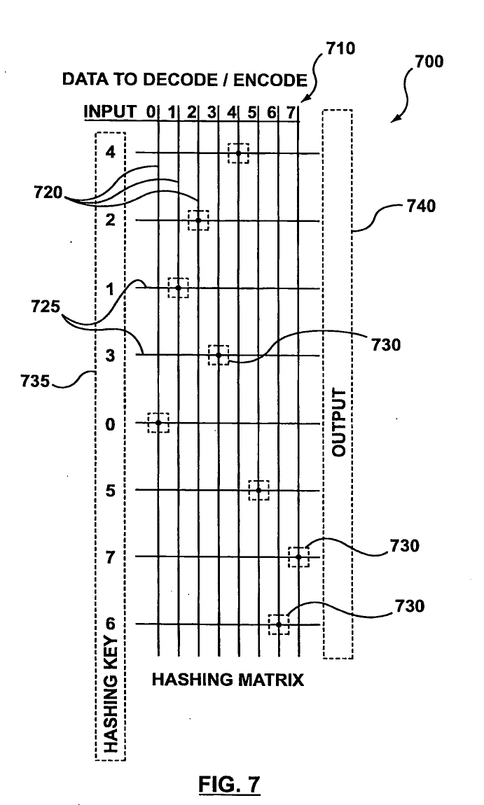

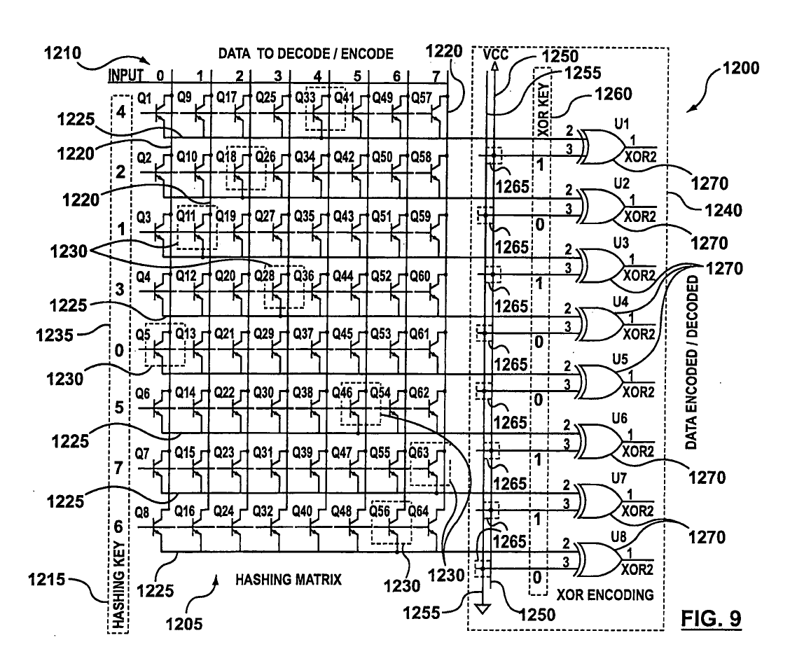

Key 140 can be set at initialization of the CPU by enabling and/or disabling certain transistors within a dedicated logic circuit (such as a transistor-based hashing matrix, an example of which is shown in FIG. 9). Alternatively, key 140 can be set at initialization by establishing conductor connections in a matrix of conductors, such as is shown in FIG. 7. The conductors in the matrix are initially unconnected and, at initialization, certain of the conductors are connected to perpendicularly oriented conductors according to the hashing function to be programmed into the hashing matrix. For example, the conductor connections can be formed during the manufacturing process by selective laser exposure of a semi-conductor substrate according to existing integrated circuit forming techniques.

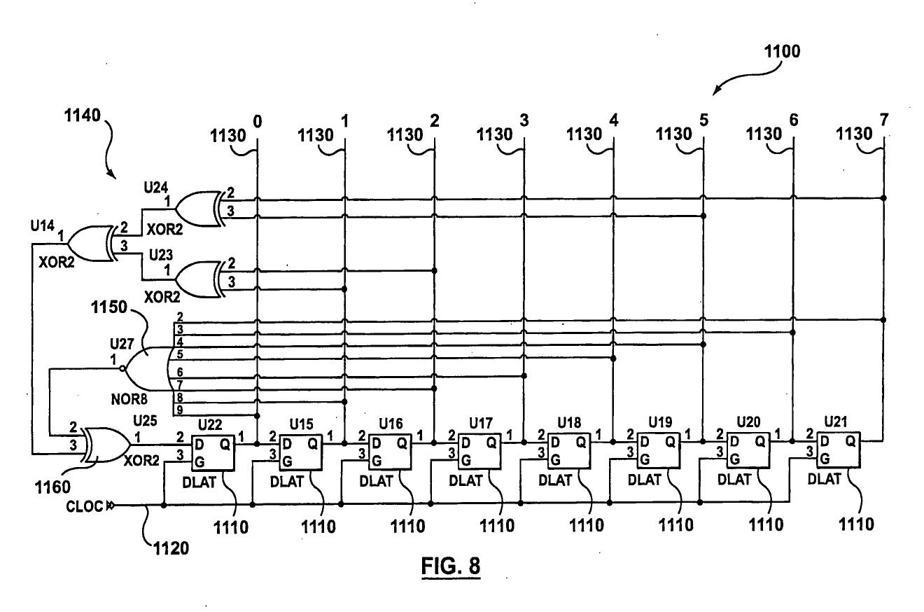

In one embodiment, the variable key can be derived from the fixed key. For example, the fixed key can be used as the seed value for a LFSR circuit (such as is shown and described in relation to FIG. 8), which generates a pseudo-random variable key with each new clock cycle. Alternatively, the variable key can be derived from the fixed key by addition or subtraction (or another mathematical function) of a varying amount.

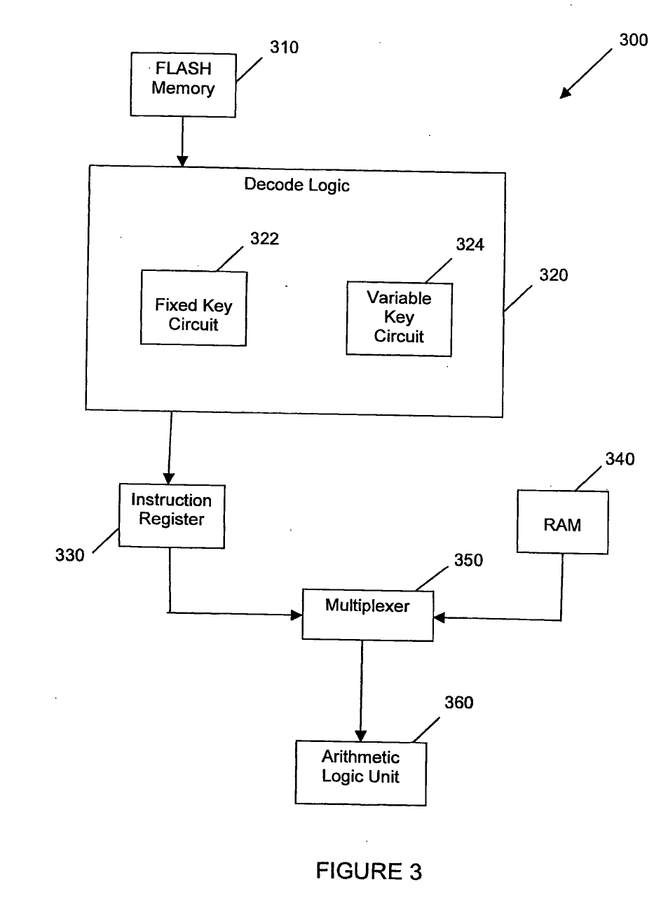

Referring now to FIG. 3, there is shown a decoding arrangement 300 for use within a CPU architecture. Data decoding arrangement 300 comprises a memory 310, such as flash memory, or other non-volatile memory, storing computer program source code. Memory 310 is an example of memory 120. The source code is executable by arithmetic logic unit (ALU) 360 once it is decoded. Memory 310 provides access to a specified memory location so that decode logic 320 can read the on or off state of the bits at the specified location. Thus, decode logic 320 effectively receives a byte from memory 310. As the memory 310 contains data that has been encrypted according to an embodiment of the present invention (for example as described in relation to FIG. 1), a byte read from memory 310 must be decoded by decode logic 320 prior to being passed on to the ALU.

Decode logic 320 has access to a fixed decryption key formed in fixed key circuit 322. Fixed key circuit 322 can either emulate a hash function encoded with the fixed decryption key or it can have the fixed decryption key hardwired within a transistor-based hashing circuit or XOR circuit (such as XOR circuit 1240 shown and described in relation to FIG. 9). Decode logic 320 executes the hash function or XOR operation using the fixed decryption key, and thus generates a decrypted byte.

If the encrypted data in memory 310 was encrypted with a variable encryption key, decode logic 320 also uses a variable key circuit 324 to further decrypt each byte. For each byte decrypted with the fixed decryption key, the variable key circuit 324 provides a specific variable decryption key for decrypting that specific byte. The specific variable decryption key for each byte is determined according to the encryption key used for encryption of the specific byte. For example, if a random or pseudo-random list of number was used during encryption, that same list is used for decryption. The variable key circuit 324 thus provides a specific variable decryption key to decode logic 320 for decrypting each byte according to the inverse logic operation to that which was used for encoding the byte. Thus, if the logic operation was an XOR operation, which is symmetrical, the same XOR operation can be used for decrypting the byte or, if the byte was encrypted with the hash function, the inverse of the hash function is used for decrypting the byte.

Depending on the type of variable key employed, variable key circuit 324 can need to include or have access to certain circuitry within decode logic 320, such as a LFSR circuit (shown in FIG. 8), or the output of the program counter or memory address register. Alternatively, the variable key circuit 324 can include or have access to a random or pseudo-random key list stored in an encrypted non-volatile memory.

A LFSR circuit advantageously creates a pseudo-random series of numbers, depending on the seed value, for a circuit having a given number of flip flops and set tapping points. Such a LFSR will generate the same pseudo-random sequence if seeded with the same seed value. Accordingly, in order to generate the same variable key sequence for decryption as used in the encryption process, it is only necessary to store the seed value used to generate the variable encryption keys, rather than storing a (potentially quite long) list of numbers in memory. Alternatively, other circuit configurations can be used to repeatably generate random or pseudo-random numbers.

Once each byte is decoded by decode logic 320, it is passed on to instruction register 330. Depending on the size of data word used in the instruction set of the CPU, for example such as a 16 bit word or a 32 bit word, the byte can be stored while awaiting one or more further bytes to complete the instruction. Depending on the particular instruction set used in the CPU architecture, the word length can be other than 8, 16 or 32 bits. Once instruction register 330 has received a complete instruction (made up of one or more decrypted bytes from decode logic 320), the instruction is passed to multiplexer 350 and then to ALU 360 for instruction processing. Multiplexer 350 coordinates input of instructions and data from random access memory (RAM) 340 to ALU 360.

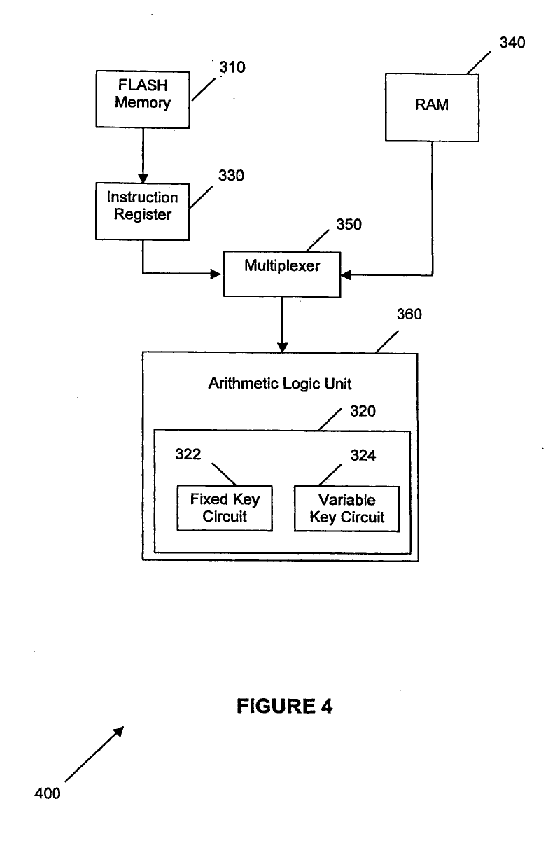

Referring now to FIG. 4, there is shown an alternative decoding arrangement 400 for a CPU. Arrangement 400 is similar to arrangement 300, except that decode logic 320 is located within ALU 360, rather than receiving the encoded bytes directly from memory 310. By locating decode logic 320 within the ALU 360, it is more difficult for the decrypted data to be observed by snooping the bus lines before it is processed by the ALU 360.

In arrangement 400, memory 310 provides the encrypted bytes to instruction register 330, which stores the bytes until enough are received to complete a data word according to the instruction set data size of the CPU. Instruction register 330 then passes the (still encrypted) data word to multiplexer 350, which coordinates the input of instructions and data (from RAM 340) into ALU 360. If multiplexer 350 receives an encrypted data word from instruction register 330, it passes the encrypted word to decode logic 320 within ALU 360, which proceeds to decrypt the data word using the key provided by, or encoded in, fixed key circuit 322 and, if applicable, the key provided by variable key circuit 324. The decrypted data word is then executed or otherwise processed ALU 360.

In arrangement 400, decode logic 320 can be configured to decrypt the individual bytes of the instruction word separately or to perform the decryption on a per-word basis. If the decryption is performed on a per-byte basis, then this is done as described above. If, however, the decryption is performed on a per-word basis, the fixed decryption key provided by fixed key circuit 322 is a word-length key, rather than a byte-length key and the variable decryption key provided by variable key circuit 324 is also a word-length key. If the memory location of a word was used to encrypt the bytes of that word during the encryption process (prior to storage in memory 310), the memory location of the word, which is the memory location of the first byte in the word, is used as the variable decryption key provided by variable key circuit 324.

If the data in memory 310 was encrypted on a per-byte basis, then in arrangement 400, decode logic 320 must decode the bytes in each instruction word on a per-byte basis and variable key circuit 324 provides each variable decryption key accordingly.

While flash memory 310 is shown and described by way of example in relation to FIGS. 3 and 4, other forms of memory can be substituted for flash memory, depending on the particular context in which the invention is applied. Such other forms of memory are not described herein for brevity and in order to avoid obscuring the invention.

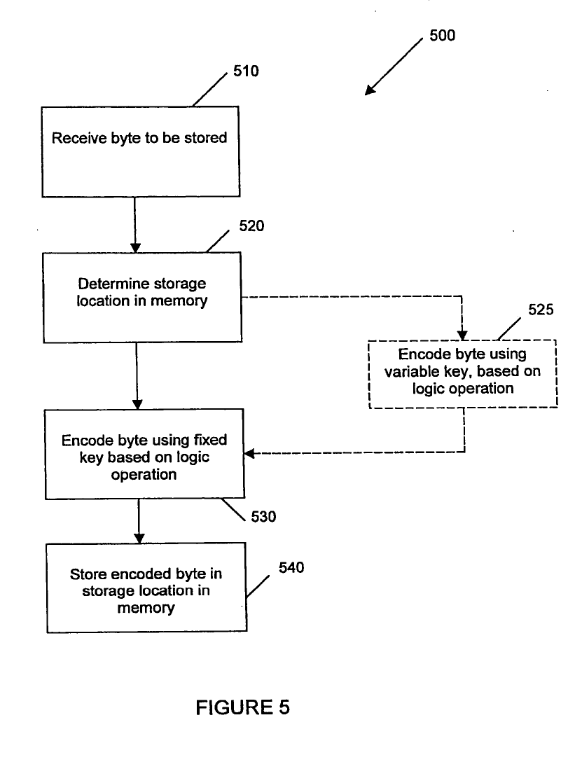

Referring now to FIG. 5, a data encoding method 500 is described. Data encoding method 500 begins by receiving bytes to be stored in memory 120 (or memory 310) at step 510. The bytes to be stored can be received in a serial and/or parallel manner from an internal bootloader, for example, which can be executed in firmware or hardware. For some types of ROM, such as standard ROM and PROM, for example, the data can be pre-encoded and stored by the memory chip manufacturer. In such a case, if the memory chip manufacturer is not the same entity as the CPU manufacturer, the chip manufacturer and the CPU manufacturer must share the encryption key(s) using the encoding so that the stored data can be read and decoded and the fixed key can be suitably written into the fixed key circuit 322 by the CPU manufacturer.

At step 520, the intended storage location of the bytes is determined, for example from the bootloader. At step 530, the byte is encoded using a fixed encryption key based on a pre-determined logic function, such as a hash function or an XOR operation. If variable key encryption is also to be used, the byte is also encrypted, at step 525, by encode logic 110 using a variable encryption key based on a logic function. The logic functions used in the fixed and variable key encryption can be the same or can be different.

The order of the fixed key encryption and variable key encryption is interchangeable, even though the variable key encryption is shown in FIG. 5 as optionally occurring prior to the fixed key encryption. Once the byte is encrypted, it is stored in the pre-determined memory location at step 540. In an alternative embodiment, step 530 can use variable key encryption, with step 525 being an optional fixed key encryption step.

In further embodiments of the invention, more than two encryption keys can be used for added security. Such further keys can be fixed or variable. Such further embodiments can use, for example, three, four or five keys, with each key being used within an extended encoding sequence in which the data is encoded with all keys according to sequentially performed logic functions (which can be the same or different). Further, a variable number of keys can be used rather than a fixed number of keys. Naturally, the number and location of the keys used in the encoding must be known to the decode logic circuit 210 or 310 in order to be able to decode the stored data.

In one embodiment, the number of keys used in the encoding can vary for each byte. For example, the number of keys can vary depending on the location of a byte or randomly or pseudo-randomly. Alternatively, the number of keys to be used in the encoding can be determined according to a pseudo-random number sequence generated by a circuit such as a LFSR circuit. In order to ensure that the degree of repetition of the pseudo-random number is low and the number of keys used is also low, the LFSR circuit preferably has in the order of four to eight stages and only the first few bits of the LFSR circuit output would be used to determine the number of keys used.

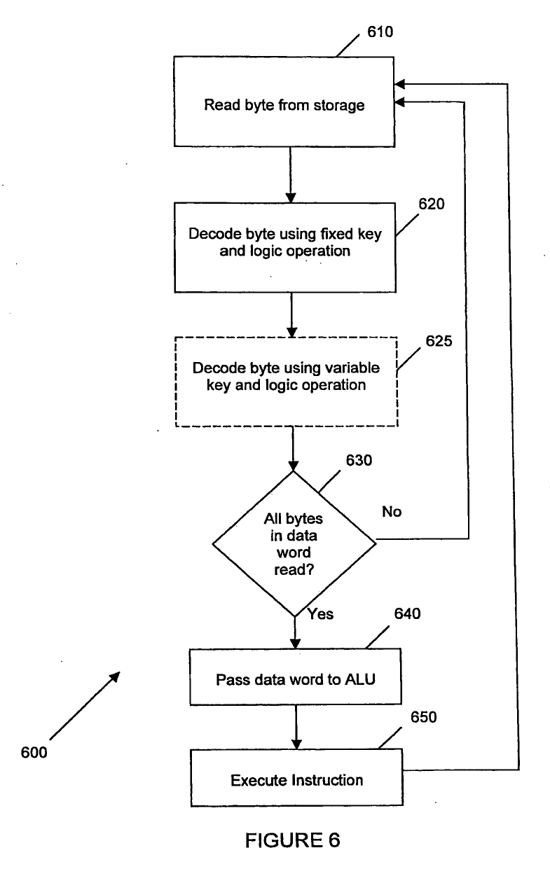

Referring now to FIG. 6, a data decryption method 600 is shown and described, based on arrangement 300 of FIG. 3. Data decryption method 600 begins at step 610 with reading an encrypted byte from storage (i.e. from memory 120 or memory 310). The byte read at step 610 is decoded at step 620 using a fixed key. The fixed key and the encoded byte are applied to a logic operation, such as an XOR operation or a hash function, which is the inverse of the logic operation used in encoding the data prior to its storage.

If the byte was encrypted using a variable key, at step 625, the byte partially decoded at step 620 is further decoded using a variable decryption key and a second logic operation. The partially decoded byte and the variable key are used as operands for the second logic operation with the resultant byte being fully decrypted. If variable key encryption was not used in encoding the data read from storage, step 625 is skipped.

The fully decrypted byte resulting from step 620 or 625 is passed to a register and stored there, pending receipt of all bytes in the data word, at step 630. If not all bytes of the data word have been read, steps 610 to 620 (and step 625 if applicable) are repeated until all bytes in the data word have been read. Once the data word register has received all decrypted bytes to form a word, the data word is passed to the ALU 360 at step 640 and the instruction represented by the data word is processed/executed at step 650. Steps 610 to 650 are performed repeatedly so long as there are further instructions to be processed.

If the word length is only one byte long, step 630 is skipped and the fully decrypted byte resulting from step 620 or 625 is passed directly to the ALU 360 at step 640.

In an alternative embodiment, step 640 can pass the data word or byte to a processor other than the ALU, for example such as a digital signal processor (DSP) for processing the data as signal data. This alternative embodiment is applicable where the data storage stores audio or video signal data, for example, rather than computer program source code. In this alternative embodiment, step 650 can comprise processing the data according to its particular data type.

In another embodiment, method 600 can also be applied to arrangement 400 of FIG. 4. In such an embodiment, the encrypted data bytes or words are read into the instruction register 330 and then passed directly from instruction register 330 to the ALU 360, where the decryption is performed using decode logic 320. Thus, in this embodiment, steps 620 and 625 are performed after step 640 and before step 650.

Referring now to FIG. 7, there is shown an example hashing matrix 700 for executing a hashing function, as part of the functions of the encode logic 110 or decode logic 210 or 320, as described above. The hashing matrix 700 comprises an array of conductors, with certain of the conductors being connected and all others being unconnected. The connected conductors are configured so as to correspond to a hashing key such that, for an example 8-bit input, each of those 8 bits can be mapped to a different bit position because of the position of each of the connected conductors within the array. These conductors can be connected by configuration fuses in a permanent configuration or can alternatively be electrically reconfigurable.

In the example shown in FIG. 7, an input byte having bit positions 01234567 is transposed by hashing matrix 700 into new bit positions 42130576 at the output.

The conductor connections can be formed in various ways, but are preferably configured so as to be one-time programmable (OTP) and not readable by magnetic polarization sensors. Thus, it is preferable to form the conductor connections on a physical level, rather than being reconfigurable on a logic level. In this way, because the fixed key is chosen to be device specific, each fixed key circuit is device-specific and the memory 310 stores data encrypted using that device-specific fixed key, which renders that data useless on other devices if copied from memory 310.

In one example, the conductor connections can be formed during the manufacturing process of the semi-conductor die. The connectors can be written into the die by selective exposure of certain conductor crossover points of conductors in the semi-conductor substrate to a laser writing beam. Such connections are then protected, preserved and concealed in subsequent steps of forming the integrated circuit.

In one embodiment, multiple fixed key circuits can be used, each having a different fixed code written into it and used for encoding and decoding different memories or different parts of the same memory.

Hashing matrix 700 comprises an input connection 710 on one side of the matrix and an output connection 740 on another side of the matrix. Input conductors 720 are oriented longitudinally, while output conductors 725 are oriented laterally to cross the input conductors. Each of the input conductors 720 and output conductors 725 are initially unconnected.

In a fixed key hard-coding procedure, in which selected connections 730 are made among the input connectors 720 and output connectors 725, connection points 730 are formed in hashing matrix 700. The configuration of connection points 730 is the fixed key in hard-coded form and the connection points 730 are formed according to the desired fixed (hashing) key 735 to be encoded in hashing matrix 700. All other locations in which input conductors 720 cross output conductors 725 remain insulated or otherwise unconnected so that each input conductor 720 is only connected to one output conductor 725 so as to ensure that the bit transposition between the input and output is one-to-one.

The hashing matrix shown in FIG. 7 can be used for encoding or decoding. If the hashing matrix is configured to encode incoming bytes, a corresponding inverse hashing matrix is also provided for the decoding process, for example as part of decode logic 320, in order to map the transposed bits back to their original positions. Alternatively, depending on the circuit configuration, the same hashing matrix can be used for the decoding, but in reverse manner.

While input conductors 720 and output conductors 725 are shown in FIG. 7 running perpendicularly, it should be understood that other conductor orientations and configurations can be employed where the conductors do not run perpendicularly, so long as they can be easily connected to each other at desired points to establish the desired hashing configuration. For example, input conductors 720 can run above and parallel to output conductors 725 but separated by a thin insulation layer whereby the insulation layer can be removed or turned conductive to connect the respective conductors as desired. It should also be understood that, instead of forming the connections of the hashing matrix by connecting selected conductors, the conductors can be pre-fabricated so that the input conductors are all connected to all of the output conductors and the fixed key is hard-coded by disconnecting all conductors except those between which connections are desired.

Connection points 730 are shown in FIG. 7 as being point connections. However, as shown in FIG. 9, conductor connections can instead be formed using other suitable connection means, such as transistors or other solid state devices.

Per-byte encoding of data according to embodiments described above is illustrated in table form in Tables 1 to 3 in appendix A. Table 1 shows example source data in the left most column (which we will call the first of six columns) in hexadecimal form. The corresponding binary source data is shown in the second column. In the example illustrated in Table 1, the binary source data is encoded by an XOR logic operation using the memory location (given by the decimal location value in column 3 and the corresponding binary location in column 4) as the variable key and is encoded (by XOR operation) with a pre-determined number as the fixed key, which in this case is 5C (hexadecimal) or 01011100 (binary). The resultant encoded and stored data is shown in binary form in column 5 and in corresponding hexadecimal form in column 6.

In the further example illustrated in Table 2, only the fixed key is changed. Instead of being 5C, the new fixed key in Table 2 is A7. As is evident from columns 5 and 6 in Table 2, the resultant encoded and stored data is different to that shown in the same columns of the table in Table 1. In Table 3, a further example is illustrated, in which the same fixed key (A7) is used, but with the variable key (i.e. the memory location) being incremented by one, in effect starting the storage from a different location. This small change in the variable key results in a change to all of the encoded and stored data, shown in columns 5 and 6 of Table 3.

Referring now to FIG. 8, there is shown an example of a LFSR circuit 1100. LFSR circuit 1100 comprises a plurality of D latches (flip-flops) 1110 connected in series and to a common clock 1120. Each of the D latches 1110 is connected to the previous D latch 1110 and to the next D latch 1110 in the series (unless it is first or last in the series). Each D latch 1110 has an output line 1130 connected to its output for outputting a voltage representative of a bit value of 1 or 0. The output lines 1130 of each D latch 1110 can also be used as feedback to a feedback logic circuit 1140, which forms part of the feedback input to the first D latch 1110 of the series.

In order to achieve the pseudo-random number generation along output lines 1130, only selected output lines 1130 are used as input to feedback circuit 1140. For example, as shown in FIG. 8, the second, third, sixth and eighth D latch output lines 1130 are used as input to feedback circuit 1140. The positions of the output lines 1130 selected for input to feedback circuit 1140 are also called tapping points. Depending on the selection of tapping points, the length of the pseudo-random number sequence (before it repeats) will vary, although there are some predetermined optimal tapping point configurations for providing a maximum pseudo-random number sequence length.

The example LFSR circuit 1110 shown in FIG. 8 has eight D latches 1110 (called an eight stage LFSR circuit) and four predetermined fixed tapping points. Depending on the desired LFSR circuit performance, different numbers of D latches 1110 can be used. Further, different numbers of tapping points and alternative tapping point configurations can be used, depending on the desired LFSR circuit performance. In one embodiment, the LFSR circuit can be configured to have variable tapping points, controllable by the microprocessor, to generate a different pseudo-random number sequence, depending on requirements.

It is necessary to provide a seed value to the LFSR circuit 1110 to begin the pseudo-random number generation sequence. This seed value can be input serially, beginning at the first D latch 1110 and propagating to the rest to the D latches 1110 over eight clock cycles. Alternatively, the D latches 1110 can be configured to allow parallel input of the seed bits in a single clock cycle.

For each clock cycle of clock 1120 the output of each D latch 1110 is provided to the subsequent D latch 1110 in the series and to an output line 1130. Thus, the bit values on each of the eight output lines 1130 depends on the output of the previous D latch 1110 from the previous clock cycle and on the feedback provided to the first D latch 1110 in the series.

In order to prevent the LFSR circuit 1110 from getting stuck on a series of zeros, the output of each D latch 1110 is also provided to a NOR gate 1150, the output of which is provided to XOR gate 1160, along with the output of feedback logic circuit 1140. The output of XOR gate 1160 is then provided as the feedback input to the first D latch 1110 of the series. Thus, if all output lines 1130 carry a 0 value, NOR gate 1150 will output a 1 value, which will allow the D latches to resume pseudo-random number generation.

Feedback logic circuit 1140 comprises, in this example of LFSR circuit 1100, three XOR gates. Two of the XOR gates each receive two of the four feedback inputs from the four tapping points and the outputs of these XOR gates are provided to the third XOR gate, which in turn provides its output to XOR gate 1160.

Referring now to FIG. 9, there is shown a particular embodiment of an encoding or decoding circuit, designated by reference numeral 1200, comprises at least part of the functions of key circuit 140 or fixed key circuit 322. Circuit 1200 can also be used, in one possible embodiment, as at least part of variable key circuit 324, together with LFSR circuit 1110. Circuit 1200 comprises a hashing matrix 1205 in combination with an XOR encoding circuit 1240. The hashing matrix 1205 is similar in operation to hashing matrix 700 (and is shown encoding the same fixed key) in that it has a hashing key 1215 encoded or formed therein according to selected circuit connections formed between input conductors 1220 and output conductors 1225 of the hashing matrix 1205.

In contrast to circuit connections 730 of hashing matrix 700, hashing matrix 1205 uses a matrix of switching devices, such as transistors 1230, for example, which interconnect input conductors 1220 with output conductors 1225. The transistors can be bipolar junction transistors (BJTs) or field effect transistors (FETs), although the transistors illustrated in FIG. 9 are BJTs. Alternatively, other solid-state semiconductor devices or simple conductors can be used to form switchable or non-switchable connections between the input conductors 1220 and the output conductors 1225. In a further alternative, a form of multiplexer configured with a fixed or variable key can be used for transposing/redirecting the bits within each byte or word.

Depending on the fixed key code to be encoded or formed into hashing matrix 1205, certain of the transistors are selected for connecting each input line 1220 to a respective output line 1225. Unselected transistors in hashing matrix 1205 are either unconnected to the input and output conductors 1220, 1225 or are disabled by having their base terminals brought low. When the base terminal of each selected transistor 1230 is high, that transistor 1230 will be enabled, thus passing the input voltage on the relevant input conductor 1220 to the output conductor 1225 to which the respective transistor 1230 is connected, thereby transposing the bit positions of input 1210 to different output bit positions. In an embodiment of hashing matrix 1205 that is reconfigurable, the base terminal of each transistor in the matrix is independently selectable, thereby allowing each input conductor 1220 to be selectively connectable to any output conductor 1225.

In the example circuit 1200 shown in FIG. 9, hashing matrix 1205 is employed in combination with an XOR encoding circuit 1240 connected to the output conductors 1225. Each of the output conductors 1225 is used as one input to an XOR gate 1270 in XOR encoding circuit 1240. The other input of each XOR gate 1270 provides one bit of an XOR key 1260 encoded into XOR encoding circuit 1240. XOR key 1260 is encoded by having the second input of each XOR gate 1270 connected to a selected one of a high input line 1250 or a low input line 1255, depending on the bit value of the XOR key 1260 to be encoded into each bit position of XOR encoding circuit 1240. For example, in order to provide a 1 to the second input of an XOR gate 1270, that input is connected, at connection 1265, to the high input line 1250. Conversely, in order to supply a 0 to the second input of an XOR gate 1270, that input should be connected at connection point 1265 to the low input line 1255. Connection points 1265 in XOR encoding circuit 1240 are preferably hard-wired and can be formed in a similar manner to connection points 730, described in relation to FIG. 7.

FIG. 9 shows XOR encoding circuit 1240 having a series of XOR encoding gates 1270 coupled to the output of the hashing matrix 1205. In the example embodiment illustrated, the XOR encoding circuit 1240 can be used to perform a further logic operation, either as part of the decoding or encoding process. Advantageously, in such an example embodiment, the XOR encoding gates 1270 can be used to perform the logic operation involving the fixed encryption or decryption key, while the hashing matrix 1205 can be used in the variable key encryption or decryption (if the hashing matrix is reconfigurable). In the example shown in FIG. 9, an input byte of value 11010111 would be transposed by hashing matrix 1205 into 00111111. The transposed byte would then be XORed with the (XOR key 1260) value 10100110 to provide an output byte of value 10011001.

While FIG. 9 shows an XOR encoding circuit 1240 in combination with hashing matrix 1205, it should be understood that either of these circuits can be substituted for alternative circuits, either having a hard-coded fixed key formed therein or generating a variable key, such as LFSR circuit 1100. However, at least one of the circuits should have a hard-coded fixed key formed therein. Circuit 1200 can be used for encoding or decoding data. If circuit 1200 is used for encoding data, a similar circuit is provided for decoding the data, except that hashing matrix 1205 will be inversely configured to transpose the bits in an inverse manner to the encoding circuit.

Alternative circuits can be used to perform the logic operations involved in the encryption/decryption, depending on the particular type of logic operation being performed. The transistors 1230 shown in FIG. 9 represent only one of a number of possible means to redirect a bit to a new position. For example, other forms of transistor or logic switch can be used instead of the transistor switches 1230 shown in FIG. 9 and other logic switch configurations can be used for logic operations other than hashing.

While embodiments of the invention have been described with reference to the drawings, it is to be understood that this description is by way of example and is not intended to limit the spirit or scope of the invention to only those embodiments described or shown. Some modifications and/or enhancements can be apparent to those skilled in the art without departing from the spirit and scope from the invention.

TABLE 1
Appendix A
Original

| Key: 5C 01011100 | | | | | XOR |
|---|---|---|---|---|---|
| Source | Source | Decimal | Binary | Saved | Saved |
| Data | Binary | Location | Location | Binary | Data |
| 2D | 00101101 | 000 | 00000000 | 01110001 | 71 |
| 3C | 00111100 | 001 | 00000001 | 01100001 | 61 |
| 4E | 01001110 | 002 | 00000010 | 00010000 | 10 |
| 2A | 00101010 | 003 | 00000011 | 01110101 | 75 |
| F4 | 11110100 | 004 | 00000100 | 10101100 | AC |
| D6 | 11010110 | 005 | 00000101 | 10001111 | 8F |
| 54 | 01010100 | 006 | 00000110 | 00001110 | 0E |
| 67 | 01100111 | 007 | 00000111 | 00111100 | 3C |
| 8A | 10001010 | 008 | 00001000 | 11011110 | DE |
| FE | 11111110 | 009 | 00001001 | 10101011 | AB |
| 7E | 01111110 | 010 | 00001010 | 00101000 | 28 |
| 8D | 10001101 | 011 | 00001011 | 11011010 | DA |
| 56 | 01010110 | 012 | 00001100 | 00000110 | 06 |
| 5B | 01011011 | 013 | 00001101 | 00001010 | 0A |
| B1 | 10110001 | 014 | 00001110 | 11100011 | E3 |
| 1D | 00011101 | 015 | 00001111 | 01001110 | 4E |
| D4 | 11010100 | 016 | 00010000 | 10011000 | 98 |
| 04 | 00000100 | 017 | 00010001 | 01001001 | 49 |
| F0 | 11110000 | 018 | 00010010 | 10111110 | BE |
| 30 | 00110000 | 019 | 00010011 | 01111111 | 7F |
| 0F | 00001111 | 020 | 00010100 | 01000111 | 47 |
| 1F | 00011111 | 021 | 00010101 | 01010110 | 56 |
| DE | 11011110 | 022 | 00010110 | 10010100 | 94 |
| BA | 10111010 | 023 | 00010111 | 11110001 | F1 |
| A0 | 10100000 | 024 | 00011000 | 11100100 | E4 |
| 55 | 01010101 | 025 | 00011001 | 00010000 | 10 |
| 44 | 01000100 | 026 | 00011010 | 00000010 | 02 |
| 12 | 00010010 | 027 | 00011011 | 01010101 | 55 |
| 00 | 00000000 | 028 | 00011100 | 01000000 | 40 |
| FF | 11111111 | 029 | 00011101 | 10111110 | BE |
| 45 | 01000101 | 030 | 00011110 | 00000111 | 07 |
| 54 | 01010100 | 031 | 00011111 | 00010111 | 17 |

The saved data is computed by doing a XOR of the source data with the key and then another XOR with the location. These examples use a simple XOR to encrypt the data.

TABLE 2
Change in Key Only

| Key: A7 10100111 | | | | | XOR |
|---|---|---|---|---|---|
| Source | Source | Decimal | Binary | Saved | Saved |
| Data | Binary | Location | Location | Binary | Data |
| 2D | 00101101 | 000 | 00000000 | 10001010 | 8A |
| 3C | 00111100 | 001 | 00000001 | 10011010 | 9A |
| 4E | 01001110 | 002 | 00000010 | 11101011 | EB |
| 2A | 00101010 | 003 | 00000011 | 10001110 | 8E |
| F4 | 11110100 | 004 | 00000100 | 01010111 | 57 |
| D6 | 11010110 | 005 | 00000101 | 01110100 | 74 |
| 54 | 01010100 | 006 | 00000110 | 11110101 | F5 |
| 67 | 01100111 | 007 | 00000111 | 11000111 | C7 |
| 8A | 10001010 | 008 | 00001000 | 00100101 | 25 |
| FE | 11111110 | 009 | 00001001 | 01010000 | 50 |
| 7E | 01111110 | 010 | 00001010 | 11010011 | D3 |
| 8D | 10001101 | 011 | 00001011 | 00100001 | 21 |
| 56 | 01010110 | 012 | 00001100 | 11111101 | FD |
| 5B | 01011011 | 013 | 00001101 | 11110001 | F1 |
| B1 | 10110001 | 014 | 00001110 | 00011000 | 18 |
| 1D | 00011101 | 015 | 00001111 | 10110101 | B5 |
| D4 | 11010100 | 016 | 00010000 | 01100011 | 63 |
| 04 | 00000100 | 017 | 00010001 | 10110010 | B2 |
| F0 | 11110000 | 018 | 00010010 | 01000101 | 45 |
| 30 | 00110000 | 019 | 00010011 | 10000100 | 84 |
| 0F | 00001111 | 020 | 00010100 | 10111100 | BC |
| 1F | 00011111 | 021 | 00010101 | 10101101 | AD |
| DE | 11011110 | 022 | 00010110 | 01101111 | 6F |
| BA | 10111010 | 023 | 00010111 | 00001010 | 0A |
| A0 | 10100000 | 024 | 00011000 | 00011111 | 1F |
| 55 | 01010101 | 025 | 00011001 | 11101011 | EB |
| 44 | 01000100 | 026 | 00011010 | 11111001 | F9 |
| 12 | 00010010 | 027 | 00011011 | 10101110 | AE |
| 00 | 00000000 | 028 | 00011100 | 10111011 | BB |
| FF | 11111111 | 029 | 00011101 | 01000101 | 45 |
| 45 | 01000101 | 030 | 00011110 | 11111100 | FC |
| 54 | 01010100 | 031 | 00011111 | 11101100 | EC |

Just by changing the key, the whole data is different from the original encrypted table.

TABLE 3
Change in Location of Data (offset by 1)

| Key: A7 10100111 | | | | | XOR |
|---|---|---|---|---|---|
| Source | Source | Decimal | Binary | Saved | Saved |
| Data | Binary | Location | Location | Binary | Data |
| 2D | 00101101 | 001 | 00000001 | 10001011 | 8B |
| 3C | 00111100 | 002 | 00000010 | 10011001 | 99 |
| 4E | 01001110 | 003 | 00000011 | 11101010 | EA |
| 2A | 00101010 | 004 | 00000100 | 10001001 | 89 |
| F4 | 11110100 | 005 | 00000101 | 01010110 | 56 |
| D6 | 11010110 | 006 | 00000110 | 01110111 | 77 |
| 54 | 01010100 | 007 | 00000111 | 11110100 | F4 |
| 67 | 01100111 | 008 | 00001000 | 11001000 | C8 |
| 8A | 10001010 | 009 | 00001001 | 00100100 | 24 |
| FE | 11111110 | 010 | 00001010 | 01010011 | 53 |
| 7E | 01111110 | 011 | 00001011 | 11010010 | D2 |
| 8D | 10001101 | 012 | 00001100 | 00100110 | 26 |
| 56 | 01010110 | 013 | 00001101 | 11111100 | FC |
| 5B | 01011011 | 014 | 00001110 | 11110010 | F2 |
| B1 | 10110001 | 015 | 00001111 | 00011001 | 19 |
| 1D | 00011101 | 016 | 00010000 | 10101010 | AA |
| D4 | 11010100 | 017 | 00010001 | 01100010 | 62 |
| 04 | 00000100 | 018 | 00010010 | 10110001 | B1 |
| F0 | 11110000 | 019 | 00010011 | 01000100 | 44 |
| 30 | 00110000 | 020 | 00010100 | 10000011 | 83 |
| 0F | 00001111 | 021 | 00010101 | 10111101 | BD |
| 1F | 00011111 | 022 | 00010110 | 10101110 | AE |
| DE | 11011110 | 023 | 00010111 | 01101110 | 6E |
| BA | 10111010 | 024 | 00011000 | 00000101 | 05 |
| A0 | 10100000 | 025 | 00011001 | 00011110 | 1E |
| 55 | 01010101 | 026 | 00011010 | 11101000 | E8 |
| 44 | 01000100 | 027 | 00011011 | 11111000 | F8 |
| 12 | 00010010 | 028 | 00011100 | 10101001 | A9 |
| 00 | 00000000 | 029 | 00011101 | 10111010 | BA |
| FF | 11111111 | 030 | 00011110 | 01000110 | 46 |
| 45 | 01000101 | 031 | 00011111 | 11111101 | FD |
| 54 | 01010100 | 032 | 00100000 | 11010011 | D3 |

In this table, the key and the source data are the same but it is shifted by one location. The result is different because of the change in the variable key (i.e. the memory location).

1. A method of retrieving data, the method comprising:
reading at least one byte of stored data from a memory associated with a processor;
for each byte read, performing a logic operation on the byte using a decryption key to generate a decrypted byte, wherein the decryption key is encoded in a dedicated key circuit accessible to the processor; and
providing each decrypted byte to the processor for processing thereof.

2. The method of claim 1, wherein the stored data is encrypted computer program source code.

3. The method of claim 1, wherein the memory is a form of non-volatile memory.

4. The method of claim 3, wherein the non-volatile memory is a form of read-only memory (ROM).

5. The method of claim 1, wherein the stored data is encrypted microprocessor data.

6. The method of claim 1, wherein the decryption key is a first decryption key and the logic operation is a first logic operation and wherein the method further comprises, for each byte, performing a second logic operation on the decrypted byte using a second decryption key to generate a further decrypted byte.

7. The method of claim 6, wherein the first logic operation is an XOR operation and the data byte and the first decryption key are operands of the XOR operation.

8. The method of claim 6, wherein the first logic operation is a first hash function encoded with the first decryption key and wherein, by means of the first hash function, bits of the data byte are transposed to generate the decrypted byte based on the first decryption key.

9. The method of claim 7, wherein the second logic operation is an XOR operation and the decrypted byte and the second decryption key are operands of the XOR operation.

10. The method of claim 7, wherein the second logic operation is a second hash function encoded with the second decryption key and wherein, by means of the second hash function, bits of the decrypted byte are transposed to generate the further decrypted byte based on the second decryption key.

11. The method of claim 6, wherein the second decryption key is a variable decryption key and the first decryption key is a fixed decryption key.

12. The method of claim 6, wherein the first decryption key is a variable decryption key and the second decryption key is a fixed decryption key.

13. The method of claim 11, wherein the variable decryption key corresponds to respective memory locations of the at least one data byte.

14. The method of claim 11, wherein the variable decryption key is different for each byte.

15. The method if claim 1, wherein the stored data have been encrypted using an encryption key which is the same as the decryption key.

16. The method of claim 1, wherein the decryption key is based on a serial number of the processor or of a device housing the processor.

17. The method of claim 1, wherein the decryption key is permanently hard-coded into the key circuit.

18. The method of claim 11, wherein the variable decryption key is generated by a linear feedback shift register (LFSR) circuit according to a predetermined seed value.

19. The method of claim 18, wherein the LFSR circuit is an eight-stage LFSR circuit having predetermined tapping points.

20. The method of claim 1, wherein the key circuit is comprised in an arithmetic logic unit (ALU) of the processor.

21. A method of storing data, the method comprising:
receiving at least one byte of data to be stored in a memory associated with a processor;
for each byte received, performing a logic operation on the byte using an encryption key to generate an encrypted byte, wherein the encryption key is encoded in a dedicated key circuit accessible to the processor; and
storing each encrypted byte in the memory.

22. The method of claim 21, wherein the data to be stored is computer program source code.

23. The method of claim 21, wherein the memory is a form of non-volatile memory.

24. The method of claim 23, wherein the non-volatile memory is a form of read-only memory (ROM).

25. The method of claim 21, wherein the data to be stored is microprocessor data.

26. The method of claim 21, wherein the encryption key is a first encryption key and the logic operation is a first logic operation and wherein the method further comprises, for each byte, performing a second logic operation on the encrypted byte using a second encryption key to generate a further encrypted byte.

27. The method of claim 26, wherein the first logic operation is an XOR operation and the data byte and the first encryption key are operands of the XOR operation.

28. The method of claim 26, wherein the first logic operation is a first hash function encoded with the first encryption key and wherein, by means of the first hash function, bits of the data byte are transposed to generate the encrypted byte based on the first encryption key.

29. The method of claim 27, wherein the second logic operation is an XOR operation and the encrypted byte and the second encryption key are operands of the XOR operation.

30. The method of claim 27, wherein the second logic operation is a second hash function encoded with the second encryption key and wherein, by means of the second hash function, bits of the encrypted byte are transposed to generate the further encrypted byte based on the second encryption key.

31. The method of claim 26, wherein the second encryption key is a variable encryption key and the first encryption key is a fixed encryption key.

32. The method of claim 26, wherein the first encryption key is a variable decryption key and the second decryption key is a fixed encryption key.

33. The method of claim 31, wherein the variable encryption key corresponds to respective memory locations of the at least one data byte.

34. The method of claim 31, wherein the variable encryption key is different for each byte.

35. The method of claim 21, wherein the encryption key is based on a serial number of the processor or of a device housing the processor.

36. The method of claim 21, wherein the encryption key is permanently hard-coded into the key circuit.

37. The method of claim 31, wherein the variable encryption key is generated by a linear feedback shift register (LFSR) circuit according to a predetermined seed value.

38. The method of claim 37, wherein the LFSR circuit is an eight-stage LFSR circuit having predetermined tapping points.

39. The method of claim 21, wherein all data to be stored in the memory is encrypted.

40. Computing apparatus comprising:
a processor;
a non-volatile memory accessible to the processor for storing at least one byte of data;
encryption circuitry configured to receive data to be stored in the non-volatile memory, encrypt each received byte based on a key by using a first logic operation and pass each encrypted byte to the non-volatile memory for storage;
decryption circuitry configured to receive encrypted bytes of data from the non-volatile memory, decrypt each byte based on the key using a second logic operation that is an inverse of the first logic operation and pass each decrypted byte to the processor; and
a key circuit having the key formed therein and accessible to the encryption circuitry and the decryption circuitry.

41. The apparatus of claim 40, wherein the key is a fixed key and the key circuit is a fixed key circuit.

42. The apparatus of claim 41, wherein the fixed key circuit has the fixed key formed therein in a non-volatile manner according to permanent electrical connections formed between selected ones of a plurality of conductors in the fixed key circuit.

43. The apparatus of claim 41, wherein the fixed key is based on a serial number of the processor or of a device housing the processor.

44. The apparatus of claim 40, wherein the non-volatile memory stores encrypted computer program source code.

45. The apparatus of claim 41, further comprising a variable key circuit configured to provide a variable key to the encryption circuitry and the decryption circuitry, wherein the encryption circuitry is further configured to encrypt each byte based on the variable key using a third logic operation before passing the encrypted byte to the non-volatile memory and wherein the decryption circuitry is further configured to decrypt each byte based on the variable key using a fourth logic operation that is an inverse of the third logic operation before passing the decrypted byte to the processor.

46. The apparatus of claim 45, wherein the variable key is different for each byte.

47. The apparatus of claim 45, wherein one or more of the first, second, third and fourth logic operations are XOR operations.

48. The apparatus of claim 45, wherein one or more of the first, second, third and fourth logic operations are hashing operations.

49. The apparatus of claim 45, wherein the variable key is generated by a linear feedback shift register (LFSR) circuit according to a predetermined seed value.

50. The apparatus of claim 49, wherein the LFSR circuit is an eight-stage LFSR circuit having predetermined tapping points.

51. The apparatus of claim 45, wherein the variable key corresponds to respective memory locations of the encrypted bytes stored in the non-volatile memory.

52. The apparatus of claim 40, wherein the encryption circuitry encrypts all data to be stored in the non-volatile memory and the decryption circuitry decrypts all data received from the non-volatile memory.

53. The apparatus of claim 40, wherein the key circuit is comprised in an arithmetic logic unit (ALU) of the processor.

54. The apparatus of claim 40, wherein the key circuit is accessible only to the encryption circuitry and the decryption circuitry.

55. The apparatus of claim 40, wherein the key circuit is formed as part of the encryption circuitry and/or the decryption circuitry.

56. The apparatus of claim 40, wherein the key is a variable key and the key circuit is a variable key circuit.
